(19) United States
(12) Patent Application Publication
(10) Pub. No.: US 2007/0236403 A1
(43) Pub. Date: Oct. 11, 2007

(54) Mobile data memory having bandpass filter characteristics

(75) Inventors: Johannes Knorr, Wien (AT); Robert Kubena, Wien (AT)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Aktiengesellschaft

(21) Appl. No.: 11/784,983

(22) Filed: Apr. 10, 2007

(30) Foreign Application Priority Data
Apr. 11, 2006 (EP) 06007609.8 EP

(51) Int. Cl. H01Q 1/50; H01Q 1/38

(52) U.S. Cl. 343/850; 343/700 MS

(57) ABSTRACT

There is described a mobile data memory for RFID application or a mobile sensor unit having an integrated circuit and an antenna. These are provided with a first and a second oscillating circuit, which are both coupled to one another by means of a coupling element. The first oscillating circuit features the integrated circuit and the second oscillating circuit features the antenna.

### CROSS REFERENCE TO RELATED APPLICATIONS

This application claims priority of European application No. 06007609.8 EP filed Apr. 11, 2006, which is incorporated by reference herein in its entirety.

### FIELD OF INVENTION

The invention relates to a mobile data memory for RFID (Radio Frequency Identification) application or a mobile sensor unit having an integrated circuit and an antenna.

### BACKGROUND OF INVENTION

Mobile data memories of this type are generally known. They are not only applied with specific transmission frequencies but they are also to be suited for use in a band range, e.g. the USA band (902-928 MHz). In addition, it is unavoidable that the components are subject to certain tolerances. The chip input impedance and the substrate dielectric constant can thus more or less vary in the case of strip line antennae for instance. Nevertheless, to avoid repercussions resulting herefrom, broadband antenna constructions were previously selected, e.g. due to their larger substrate thickness or especially larger antenna shapes. Furthermore, more expensive substrates exist, with which a narrower tolerance of the dielectric constant can be achieved.

### SUMMARY OF INVENTION

To that effect, an object underlying the invention is to improve a mobile data memory of the abovementioned type such that a bandpass filter characteristic is achieved.

The object is achieved by means of a first and a second oscillating circuit, which are both coupled to one another by means of a coupling element, with the first oscillating circuit featuring the chip and the second oscillating circuit featuring the antenna.

Advantageous developments of the invention emerge from the subclaims.

In accordance with claim 3, it is particularly advantageous if the antenna is embodied as a strip line antenna.

### BRIEF DESCRIPTION OF THE DRAWINGS

An exemplary embodiment of the invention is described in more detail below with reference to the drawings, in which;

FIG. 1 shows an inventive mobile data memory for RFID application,

FIG. 2 shows an electrical equivalent circuit of the mobile data memory according to FIG. 1 and

FIG. 3 shows the frequency response which is characteristic for a bandpass filter structure according to the invention.

### DETAILED DESCRIPTION OF INVENTION

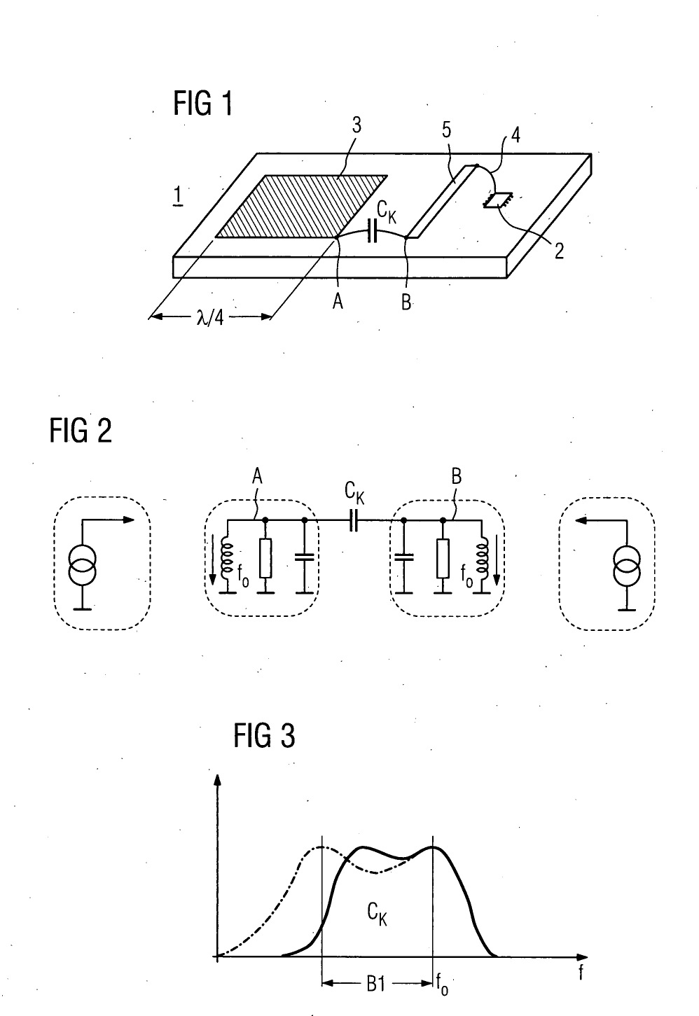

FIG. 1 shows a mobile data memory 1 for RFID (Radio Frequency Identification) application, also referred to as a transponder or a tag, which, in a known manner, comprises an integrated circuit 2 (e.g. a chip) and an antenna 3. In accordance with the invention, the antenna 3 is adjusted by means of a bandpass filter structure such that a frequency response according to FIG. 3 is achieved.

The bandpass filter structure is generated by two oscillating circuits, which can be embodied as parallel or series oscillating circuits and which can be coupled to one another by means of a capacitive or inductive coupling element. A transformer can serve as an inductive coupling element for instance.

In the exemplary embodiment according to FIG. 1, the mobile data memory 1 is embodied with two parallel oscillating circuits coupled by a coupling capacitor C_{K} as a coupling element. In this way, the first parallel oscillating circuit features a λ/4-strip line antenna 3, which exhibits a through-connection to ground. The second parallel oscillating circuit is essentially formed by a series circuit made of the integrated circuit 2, an inductive resistor 4 and a λ/4-line 5 (e.g. a λ/4 transformer). In this way, the λ/4-line 5 has the attribute of transferring a series oscillating circuit into a parallel oscillating circuit and vice versa. In the present exemplary embodiment, the series oscillating circuit formed from the integrated circuit 2, which shows both an ohmic and also a capacitive load, and from the inductive resistor 4, is transferred into a parallel oscillating circuit.

This results in a bandpass filter structure, the equivalent circuit of which is shown in FIG. 2, it being possible for a magnetic coupling element, e.g. a transformer or a simple coil to also be applied as a coupling element, in place of the capacitor C_{K}.

The antenna 3 represents a series or parallel oscillating circuit depending on the feeding method. In the simplest form, the feeding is a parallel oscillating circuit, as in the present exemplary embodiment by way of a micro strip line or also with coaxial feeding.

In accordance with FIGS. 1 and 2, the bandpass filter structure offers a first feeding point A and a second feeding point B.

In FIG. 2, the first parallel oscillating circuit is shown on the left with the antenna 3 pointing to “receipt” and the second parallel oscillating circuit with the integrated circuit 2 is shown on the right pointing to “send”. On receipt, a receive voltage U_{A} is present here on the first parallel oscillating circuit and on sending, a sending voltage U_{B} is present on the second parallel oscillating circuit.

FIG. 3 shows the frequency response which is characteristic of an inventive bandpass filter structure of the mobile data memory 1. Resonance points which lie more or less adjacent to one another, i.e. a corresponding bandwidth B1, result as a function of the strength of the coupling of both oscillating circuits through the coupling element, i.e. by means of the coupling capacitor C_{K}. One of the resonance points here bears the reference character fₒ.

The mobile data memory 1 according to the invention enables use with higher bandwidths, e.g. in the case of the USA bandwidth (902-928 MHz). Furthermore, it is possible to intercept component tolerances (e.g. in respect of chip input impedance and substrate dielectric constant) as a result of the larger overall bandwidth. Instead of the immobile data memory, a mobile sensor unit can also be embodied in accordance with the invention.

1.-6. (canceled)

7. A mobile data memory, comprising:
a first oscillating circuit having an integrated circuit; and
a second oscillating circuit having an antenna coupled to the first oscillating circuit via a coupling device.

8. The mobile data memory as claimed in claim 7, further comprising a radio frequency identification.

9. The mobile data memory as claimed in claim 8, wherein a bandpass filter comprises the first oscillating circuit and the second oscillating circuit

10. The mobile data memory as claimed in claim 9, wherein the coupling device is a transformer.

11. The mobile data memory as claimed in claim 9, wherein the coupling device is a capacitive device.

12. The mobile data memory as claimed in claim 9, wherein the first oscillating circuit and the second oscillating circuit are parallel oscillating circuits.

13. The mobile data memory as claimed in claim 12, wherein the antenna is a strip line antenna.

14. The mobile data memory as claimed in claim 8, wherein an inductive resistor is electrically connected in series to the integrated circuit.

15. The mobile data memory as claimed in claim 8, wherein a λ/4 line is electrically connected in series to the integrated circuit and an inductive resistor.

16. A mobile sensor, comprising:
a first oscillating circuit having an integrated circuit; and
a second oscillating circuit having an antenna coupled to the first oscillating circuit via a coupling device.

17. The mobile sensor as claimed in claim 16, further comprising a radio frequency identification.

18. The mobile sensor as claimed in claim 17, wherein a bandpass filter comprises the first oscillating circuit and the second oscillating circuit

19. The mobile sensor as claimed in claim 18, wherein the antenna is a strip line antenna.

20. The mobile sensor as claimed in claim 19, wherein a λ/4 line is electrically connected in series to the integrated circuit and an inductive resistor.

21. A RFID device, comprising:
a first oscillating circuit having an integrated circuit;
a second oscillating circuit having an antenna coupled to the first oscillating circuit via a coupling device; and
a bandpass filter having the first oscillating circuit and the second oscillating circuit

22. The RFID device as claimed in claim 21, wherein the antenna is a strip line antenna.

23. The RFID device as claimed in claim 22, wherein a λ/4 line is electrically connected in series to the integrated circuit and an inductive resistor.
